(19) United States
(12) Patent Application Publication
(10) Pub. No.: US 2004/0117192 A1
(43) Pub. Date: Jun. 17, 2004

(54) System and method for reading addresses in more than one language

(75) Inventor: Udo Miletzki, Konstanz (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS AG, MUNICH (DE)

(21) Appl. No.: 10/724,095

(22) Filed: Dec. 1, 2003

Related U.S. Application Data
(63) Continuation of application No. PCT/DE02/01808, filed on May 18, 2002.

(30) Foreign Application Priority Data
Jun. 1, 2001 (DE) 101 26 835.1

(51) Int. Cl. G10L 11/00

(52) U.S. Cl. 704/277

(57) ABSTRACT

The present invention relates to a method and system for reading address in more than one language of which at least one has a non-Latin lettering. The device comprises, for each provided language, an OCR character recognition unit for reading the characters in the fields with the address blocks, whose reading results are depicted in a language-neutral transliteration representation. The device also comprises an address analysis unit for analyzing the characters read in the OCR character recognition units in which the different address elements are determined and classified using language-related syntax rules. The inventive device additional comprises an address interpretation unit for verifying the identified address element with the aid of an address database containing language-dependent transliteration variants that are different for each entry. When the read address to be verified corresponds with one of the transliteration variants of an entry or in the event of a similarity with the designated similarity measure, the address is accepted.

### CONTINUATION INFORMATION

The present application is a continuation of International Application PCT/DE02/01808, filed 18 May, 2002 which designated the United States and further claims priority to priority document 10126835.1, filed 1 Jun., 2001, the both of which are herein incorporated by reference.

### BACKGROUND OF THE INVENTION

The present invention relates to a system and method for reading addresses in more than one language, at least one of which is written in a non-Latin script. Most Western countries and some Eastern countries use Latin script for their European language, supplemented with special national characters which may generally be Latin letters provided with diacritical symbols.

Writing systems arose originally in one language area or cultural area. Later, writing systems were transferred from one language area to others. In particular, alphabetic characters, that is to say sound-encoded characters, are in themselves independent to a particular language. However, all sequences of characters (strings) are dependent on a particular language; character sequences which encode words are the elements of a language.

At present, in the Western world address readers are used on a standardized basis which automatically read the addresses on items of mail and often interpret them up to the destination. In contrast, automatic reading and interpretation of addresses in languages with non-Latin scripts, for example in regions of Eastern Europe, Africa and Asia, are still in the early stages of development. In these countries, the reading process, assuming it has been automated, is often restricted to reading the postcode. Reading the entire address up to the destination is not possible with conventional technology. Additionally, in many of these countries, at least one local official language is used alongside English. This is because English has assumed the position of a global international business language, or at least the global international post language. In certain countries, such as India, several official languages may be employed. Accordingly, a great need exists for multi-language postal address reading, the multiple languages including at least one non-Latin script. Appropriate solutions in the art have, to date, been unavailable.

### SUMMARY OF THE INVENTION

The present invention is directed to a system and method for reading multiple languages. One application is in the postal automation arts, wherein the language is a postal destination address. The instant system is directed to implementing the instant method, itself being low in complexity. Further, the multiple languages include non-Latin based script.

Language script comprises address blocks. In regions with address blocks, address characters are read by means of OCR character recognition units. A separate OCR character recognition unit may be provided for each language one anticipates will be present in the address block. The OCR units may preferably differ only in character models used. Accordingly, the OCR units may be considered multilingual. Using such OCR units, the reading results may be output in a script-neutral transliteration representation.

The present invention includes an address analysis unit. The address analysis unit includes reference language related syntax rules. These rules are applied to read addresses in order to classify the addresses accordingly. In particular, the rules are applied to the read and determined characters of the read addresses. For example, one determination of the address characters is whether they are of the type which relate to a “road” or a “place”. The address elements which are read and verified using an address database. The address database includes relevant language dependent transliteration variants. The relevant language is the anticipated language of the address characters or entries. Accordingly, multilingual address interpretation may take place.

When the read address which is to be verified corresponds to one of the transliteration variants of an entry or when there is a similarity within a defined degree of similarity, the address is accepted. If such conditions do not occur, e.g. the similarity is outside the defined degree of similarity to a transliteration variant, the read address is rejected.

In contrast to the preceding processing steps, there is only language-independent address interpretation. Only the address database contains different language-dependent transliteration variants which are treated as different writing variants in one and the same language. The differences in script are eliminated through standardization by means of the character recognition which is separate for each script. The scripts are transformed to a script-neutral representation level, the level of transliteration.

It is thus advantageous to determine the regions with the address blocks in the recorded surfaces by means of language-dependent layout models which are generated from learning samples, and when there is a defined similarity to the address block in the respective layout, the examined region is defined as an address region. In addition, a pictorial segmentation of the address block is carried out into line regions, word regions, and character regions.

It is also advantageous, at the early stage of the image processing, that is to say even before the actual character recognition, to feed the segmented image data of the address blocks to a language decision unit wherein an assignment is made as to the feature set with the greatest correspondence, and thus to the corresponding language, on the image level by comparisons with language-typical feature sets.

This results in the advantageous refinement of the reading of the address block in the OCR recognition unit for the language which was determined in the language decision unit. If no address which is to be assigned is found in the course of the reading process up to the interpretation of the address, the reading process is repeated with OCR recognition units for further languages in the sequence of the probability which was determined for each language by the language decider, until the reading result is accepted.

If it is not possible to obtain an accepted reading result of the address with any of the OCR recognition units, the parts of the address which are identified as words are read in a word recognition unit which includes corresponding decision criteria for each anticipated language of the identified words.

It is also advantageous to correct the address elements in accordance with the entries if there are similarities between the address elements produced by the read process and the reference entries in the address database within the defined degree of similarity.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 shows a block circuit diagram of a multi-language reading system; and

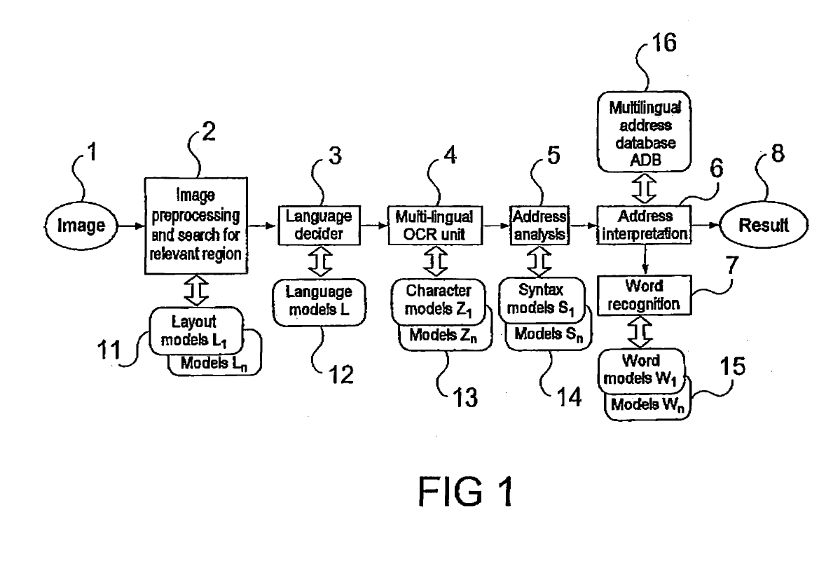

FIG. 2 shows a flowchart relating to the method sequence.

### DETAILED DESCRIPTION OF THE INVENTION

A scan is made of surfaces comprising languages to be interpreted. The scan results in an image of the surface 1. The image is feed into a processing unit 2 for “cleaning” such that to the extent possible, non-script information in the image is removed and only script images remain. With respect to applications in the postal arts, the address block at issue, e.g. destination address, is located and filtered by means of language-dependent layout models 3.

The layout models include, in statistical form, information on position and extent of relevant address blocks in a representative learning sample. In other words, the information as to where the relevant address block is to be expected in the currently present item of mail. Depending on the language and script, it is necessary to generate and apply separate layout models. Various languages and script employ vastly different locations for their address blocks. Such languages include: English or Latin script, Arabic or Arabic script, Korean and Hangul script. In contrast, the Latin scripts are so similar that as a rule only one layout model is used for the European Latin/Greek/Cyrillic group of scripts.

All the blocks are weighted in accordance with their position on the sensed surface or their relation to neighboring blocks in accordance with the values obtained empirically from the layout models.

The block with the highest weighting constitutes, with the greatest probability, the required address block. When there is a plurality of layout models, the blocks which are respectively given a maximum value for each language or script, are further-processed as potential blocks. In addition, the address blocks are segmented into lines and character sections according to pictorial properties.

A subsequent language decision unit (multi-lingual OCR unit) 4 subjects the offered segmented image data of the address block to an analysis which is tailored to the language or script before the text is recognized. This is effected on the basis of pictorial features. A language-dependent feature set comprising a small number of features determines whether an offered block belongs to one language or another. In the case of English and Arabic, these features are, inter alia, information on left justification or right justification or centeredness which are determined statistically. For example, English destination address blocks are never right-justified and seldom centered. On the other hand, Arabic ones are usually right-justified, sometimes centered, and never left-justified.

Other features may include frequency, density of diacritical dots, or continuation of characters, below the base line of a text line. For example, characters continue relatively rarely (jgpy) in English or Latin. However, characters continue frequently in Arabic. Dots below the base line theoretically never occur in the Latin script, but occur frequently in Arabic (ba, ya). Dots above the line occur rarely in English or in the Latin script (ij), but occur frequently in Arabic (ta, tha, kha, dal, zayy, shin, dad, ayn, ghayn, fa, qaf, nun).

After the process of the language decision has been carried out, and the assumed language Lᵢ is determined, a particular OCR character recognition unit 5 is employed. The particular OCR 5 is selected from among a plurality of OCRs particularly tailored to the determined language or script. The OCR 5 processes the script and returns corresponding evaluations. The evaluations may take the form of character/word recognition suggestions with assigned or associated credibility values. The language-dependent address syntax of these results is checked in an adjoining address analysis unit 6.

In unit 6, the address elements are determined and classified using syntax models 11. This employs packets, inter alia, use of individual keywords or designators such as “road”, “number”, “ZIP code” etc. which are searched for in the address. The hierarchy of the address elements such as <state>, <town>, <road>, <ZIP code> etc. is therefore found.

Next, the address is verified using the address interpretation unit 7. The verification may take the form of a confirmation, correction or rejection of the address by means of and/or consultation with an address database.

In contrast to the preceding processing stages, during the address interpretation there is only one language-independent address interpretation with an address database. This address database contains different language-dependent variants, referred to as aliases, per entry. The aliases are treated as writing variants of a language. The script differences are eliminated by standardization by means of the multilingual OCR recognition—a separate OCR recognition unit 5 per language—and transformed to a language-neutral representation level: the level of transliteration.

For example, the capital of Greece appears as the English variant ATHENS, as the German variant ATHEN, as the French variant ATHÈNE, and as the Greek variant ATINAI, a literal transliteration of the original Greek text: Aθτναι.

In order to interpret the address, the individual, relevant address elements are “looked up” in the non-lingual address database—12—, i.e. access is made to identical or the most similar entries. If the character string is precisely found, it is accepted as correct. If a precise or identical character string is not found but a similar string (without further competing strings in the proximity) is found, (i.e. for example, the Levenstein interval from the most similar entry is greater than an acceptance threshold which is provided) the string is outputted as a result given the high degree of reliability or confidence. In all other cases, results are rejected. If there is a ZIP code, it is correlated with the corresponding parts of the address. Only the addresses whose ZIP code do not contradict the address are then accepted as “correctly read”.

If the address interpretation failed, the interpretation is repeated in word recognition unit 8. In the repetition, the address elements are read with language related criteria. Failed address interpretations generally result from a combination of handwritten and machine generated script. By address interpretation, it is mane individual character segmentation process and classification process.

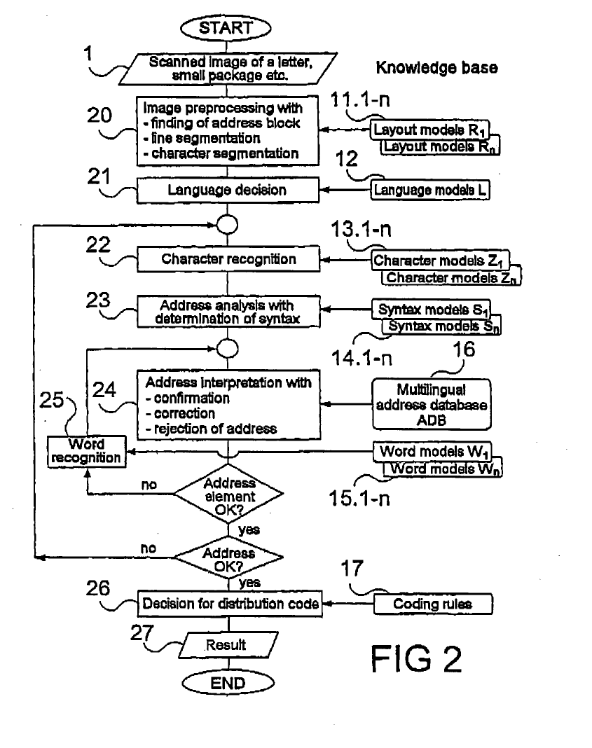

If the language decision unit 4 has made a decision on the basis of the image features, such decision is subject to further verification given the possibility for error. Here, a jump back from the end of the processing chain is provided and this jump back can revise this decision on the basis of “greater knowledge”. For example, the address analysis mainly finds poorly detected characters which do not have any meaning during the subsequent attempt at further interpretation. In this case, the next language channel 5 with the corresponding character models—10—is aimed at. This method sequence is depicted in FIG. 2.

A scanned image 1 is made of an address bearing surface. The image is then processed 20 wherein disruptive background information is eliminated and the region with the address block is determined using language-related layout models 11.1 to 11.n. Here, each layout model is compared with the image. If there is a correspondence or a similarity within a defined degree of similarity, the address block is assigned that language. In addition, line and character segmentation of the address block is analyzed. Pictorial comparisons are made between the address blocks, parts of addresses and address characters and corresponding language models 12.1 to 12.n. The degree of correspondence influences the decision of language, which is now made in step 21. In this way, the OCR character recognition unit is activated for this language and the character recognition 22 is carried out by means of the associated character set model 13.1 to 13.n.

The various OCR character recognition units can also be composed of only one central unit with various character set models, in which case the associated character set model is activated in accordance with the selected language.

In the subsequent address analysis 23, the characters which are read are classified using syntax models 14.1 to 14.n. These models are also language-related, i.e. the analysis is carried out using the syntax models of or for the selected language.

If the address analysis 23 is successful, the address elements are verified in an address interpretation 24 by reference to the address database with the language-dependent transliteration variants. When there is correspondence or similarity within the defined degree of similarity, the address elements and the address are accepted. Here, the address elements may be corrected in accordance with the entries in the database in the case of similarities.

If the address elements could not be resolved with individual character recognition 32, word recognition 25 is implemented. This procedure returns the word meanings which are sorted according to probability for each word image. The word recognition is called as often as necessary for all the address elements to be recognized or all the orders to be processed. If the address elements are resolved 34, a determined is made whether the address is in order 36. If the address is not in order, the method returns 38 to the language decision steps and process continues with the next probable language. If the address was resolved correctly 40, the distribution codes are determined for the accepted addresses 26 in accordance with coding rules 17, themselves defined by the dispatch services. Accordingly, a result 27 is arrived at and the process ends 42.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

I claim:

1. A method for reading addresses in more than one language, comprising the steps of:
reading address characters using OCR means, said OCR means being directed to an anticipated language of said characters;
depicting results of said reading in language-neutral transliteration form;
determining and classifying address elements according to anticipated language related syntax rules, said address elements comprising said address characters; and
verifying if each of said elements substantially match a database entry, said match comprising a defined degree of similarity, and said database comprising entries of acceptable read address elements with different, language dependent, transliteration variations.

2. The method according to claim 1, further comprising the steps of:
prior to said step of reading address characters, recording an image of an address bearing surface;
determining in said image regions comprising said address blocks, said step of determining in said image being performed by means of language related layout models, said models being generated from learning samples; and
pictorially segmenting said address blocks so as to produce segmented image data.

3. The method according to claim 2, further comprising the steps of:
feeding said segmented image data into a language decision unit;
determining a corresponding language by comparing said blocks with language-typical feature sets, whereby said language has a highest comparison rate; and
assigning said language as said anticipated language.

4. The method according to claim 3, further comprising the steps of: repeating said step of determining a corresponding language and assigning said language if said step of reading address characters fails with a previously assigned language.

5. The method according to claim 1, wherein if said step of reading address characters fails to resolve said address characters with said OCR means, reading identified words of said address in a word recognition unit, said word recognition unit comprising decision logic according to said anticipated language, and verifying results of said word recognition unit with said database.

6. The method according to claim 1, further comprising the steps of: repeating said steps of reading address characters, depicting results, determining and classifying address character elements with other languages than said anticipated language if said elements do not substantially correspond to database entries.

7. The method according to claim 4, further comprising the steps of: repeating said steps of reading address characters, depicting results, determining and classifying address character elements with other languages than said anticipated language if said elements do not substantially correspond to database entries.

8. The method according to claim 1, wherein if said element substantially but not completely matches a database entry, changing said element to completely match said database entry.

9. The method according to claim 1, wherein at least one of said languages is non-Latin based.

10. A system for reading addresses in more than one language, comprising:
an optical character recognition (OCR) unit directed to anticipated languages of characters of said addresses, said characters being positioned in address blocks, said OCR unit comprising means for reading said addresses and depicting results in a language-neutral transliteration representation;
an address analysis unit for evaluating characters read by said OCR unit, said address analysis unit comprising means for determining and classifying address elements by reference to anticipated language-related syntax rules; and
an address interpretation unit for verifying identified address elements using an address database, said database comprising different, language-dependent transliteration variants for each database entry, said address being verified or accepted when each of said address elements is substantially similar to a database entry, wherein a level of similarity is predefined.

11. The system according to claim 10, further comprising:
means for generating an image of a surface containing address blocks;
means for determining said address blocks based upon anticipated language related layout models, said models generated from learning samples; and
means for pictorially segmenting said address blocks.

12. The system according to claim 11, further comprising a language decision unit, said language decision unit comprising:
means for receiving said segmented image data; and
means for designating an anticipated language by comparing said blocks with language typical feature sets such that said anticipated language is a language having a highest degree of comparison with said blocks.

13. The system according to claim 12, further comprising a word recognition unit for reading parts of said address, said parts comprising words, said word recognition unit operable when reading results of said OCR unit are not verifiable, said word recognition unit comprising decision logic of each anticipated language, and said word recognition unit further comprising means for feeding results to said address interpretation unit.
